(19) United States
(12) Patent Application Publication
(10) Pub. No.: US 2010/0252507 A1
(43) Pub. Date: Oct. 7, 2010

(54) Magnetic Bead Retention Apparatus and Method

(76) Inventors: Frederic Lacharme, Lausanne (CH); Martin Gijs, Ecublens (CH)

Correspondence Address: STURM & FIX LLP, 206 SIXTH AVENUE, SUITE 1213, DES MOINES, IA, 50309-4076, US

(21) Appl. No.: 12/160,942

(22) PCT Filed: Jan. 26, 2006
(86) PCT No.: PCT/EP2006/050459

§ 371 Date: Jun. 7, 2010

(51) Int. Cl. B03C 1/00; B03C 1/30

(52) U.S. Cl. 210/695; 210/222

(57) ABSTRACT

An apparatus for retaining magnetic particles in self-assembled magnetic particle structures in a liquid flow, comprises a micro-channel (5) and magnets (1,2) for generating a substantially static magnetic field across the micro-channel (5) such that magnetic particles (12) suspended in a liquid in the micro-channel (5) form magnetic particle structures (15). The micro-channel (5) has along its length transverse large sections (8) alternating with narrow sections (9). The large sections (8) are periodically distributed along and on either side of the narrow sections (9) so that in use magnetic particle structures (15) form across the large sections (8) of the micro-channel (5), the magnetic particle structures being retained by engagement of end parts (18) of the magnetic particle structures in the large sections (8) of the cell or channel (5). The apparatus is useful in particular in life science, chemistry and microfiltration applications by flowing through the micro-channel (5) a fluid carrying molecules or particles to be captured, filtered or activated by the magnetic structures (15).

### FIELD OF THE INVENTION

The invention relates to apparatus for retaining magnetic particles in self-assembled magnetic particle structures in a liquid flow, and the use of such apparatus in particular in life science, chemistry and microfiltration applications.

The invention concerns in particular an apparatus and a method wherein the magnetic particles are used for selectively capturing target molecules or target particles suspended in and carried by a fluid flowing through a flow-through cell, as is done for instance in clinical chemistry assays for medical diagnostic purposes.

### BACKGROUND OF THE INVENTION

It is known that magnetic particles (‘beads’) embedded in a liquid can be used to carry a probe molecule on their surface that specifically interacts with a complementary target molecule (for example single stranded probe DNA interacting with complementary target DNA). Upon reaction with a molecule to be probed and, for example, using optical or electrochemical measurements, one can determine the amount of target molecules on a bead or within a certain volume containing beads (see for example Hsueh et al., Techn. Digest Transducers '97, p. 175 (1997)). The very interesting point of using magnetic microbeads, is that they can be manipulated using magnetic fields irrespective of fluid motion. In this way one can create an important relative motion of the beads with respect to the fluid and, hence, a large probability of binding a target molecule to a probe molecule fixed on the bead surface. One can then magnetically extract the beads to a place of detection/collection. Historically, beads have been locally fixed by using external magnets or have been transported using mechanically moving external magnets. The latter procedure may be for example used to fabricate mixing devices (Sugarman et al., U.S. Pat. No. 5,222,808 (1992)) and in immuno-assay methods (Kamada et al., U.S. Pat. No. 4,916,081 (1987)).

An elegant way to keep magnetic particles in a fluidic channel was based on an electromagnet consisting of a coil and at least one pair of poles of a magnetic material. Such poles form an inhomogeneous field transverse to the channel which effectively ‘traps’ the particles in regions where the field is strongest (Elsenhans et al., EP 1,331,035-A1). In the latter publication, the prior art of magnetic particle retention devices in microfluidic channels is well described. EP 1,331,035-A1 describes a flexible way of handling magnetic particles, though this requires a complex magnetic apparatus and electrical current manipulation. Specially corrugated pole tips need to be realised to generate the locally inhomogeneous magnetic field.

In another reference, Yellen and Friedman (J. Appl. Phys. 93, 8447 (2003)) describe the use of micropatterned holes in a photoresist layer with at the bottom of the hole, a ferromagnetic thin film. When placed in a magnetic field, the magnetic film focuses the field and a magnetic chain is formed when a magnetic bead-containing solution is placed above the substrate. The idea was to form arrays of bead chains at regular positions of the substrate.

In another study (Forbes et al., IEEE Trans. Magn. 39, 3372 (2003)), these authors propose such ‘magnetic trapping’ by embedding magnetic particles in the wall of a soft polymer microfluidic channel for anchoring magnetic chains over the cross-section of a microchannel in order to resist to a fluidic flow.

Doyle et al. (Science 295, 2237, 2002) and Minc et al. (Anal. Chem. 76, 3770 (2004) have proposed to use magnetic columns, as clustered by a constant magnetic field, for the separation of long DNA molecules. This was the first report of such columns as stationary phases in a chromatography application. Resistance to a fluid flow is zero as a microchannel with homogeneous cross-section is used.

Magnetic particle columns have thus been used in microfluidic channels, but in flow-through channels of homogeneous cross-section, so that the resistance to a fluid flow is minimum.

### SUMMARY OF THE INVENTION

The invention relates to an apparatus for retaining magnetic particles in self-assembled magnetic particle structures in a liquid flow, of the type comprising a flow-through cell or channel in which magnetic particles are suspendable in a liquid that is flowable through the cell or channel, and means for generating a substantially static magnetic field across the cell or channel such that when magnetic particles are suspended in a liquid in the cell or channel and the magnetic field is applied the particles form magnetic particle structures that are sustained by magnetic forces acting on the particles.

According to the invention, the flow-though cell or channel has along its length transverse large sections alternating with narrow sections. The large sections are periodically distributed along and on either side of the narrow sections, arranged such that in use magnetic particle structures form across the large sections of the cell or channel. In use, the liquid is flowable along the cell or channel through the narrow sections and through corresponding middle parts of the magnetic particle structures in the large sections, the magnetic particle structures being retained by engagement of end parts of the magnetic particle structures in the large sections of the cell or channel.

The alternating large and narrow sections in the flow-though cell or channel permit the formation of chain-like magnetic particle structures using simple magnetic apparatus and good retention of these chain-like magnetic particle structures in the flow-though cell or channel without a need for additional retaining means.

The invention also relates to a corresponding method for retaining magnetic particles in self-assembled magnetic particle structures in a liquid flow, in particular comprising flowing through the cell or channel a fluid carrying molecules or particles to be captured, filtered or activated by the magnetic structures, as well as uses of the apparatus and further features of the apparatus, as set out in the claims and the following description.

### BRIEF DESCRIPTION OF THE DRAWINGS

The invention will be further described by way of example with reference to the accompanying drawings, in which:

FIG. 1a is a schematic plan view of an apparatus according to the invention;

FIG. 1b shows a detail of FIG. 1 on an enlarged scale, looking from above FIG. 1a;

FIG. 1c is a schematic end view of an apparatus according to the invention, looking along the x direction of FIG. 1a;

FIG. 1d shows a detail of FIG. 1c on an enlarged scale, looking sideways at the channel in the middle of the device, along the y direction of FIG. 1c;

FIG. 2a is a schematic diagram showing magnetic beads in a microfluidic channel structure of varying width, with no liquid flow and no applied magnetic field;

FIG. 2b is a corresponding diagram still with no liquid flow, but with an applied magnetic field;

FIG. 2c is a corresponding diagram with liquid flow and with an applied magnetic field;

FIG. 3 is a diagram of two interacting beads;

FIGS. 4a and 4b are diagrams of two interacting magnetic chains;

FIGS. 5a, 5b and 5c show different ways of parallelising the implementation of the invention in microfluidic structures, and

FIGS. 6a and 6b show a lay-out and a photograph of an experimental version of the invention.

### DETAILED DESCRIPTION

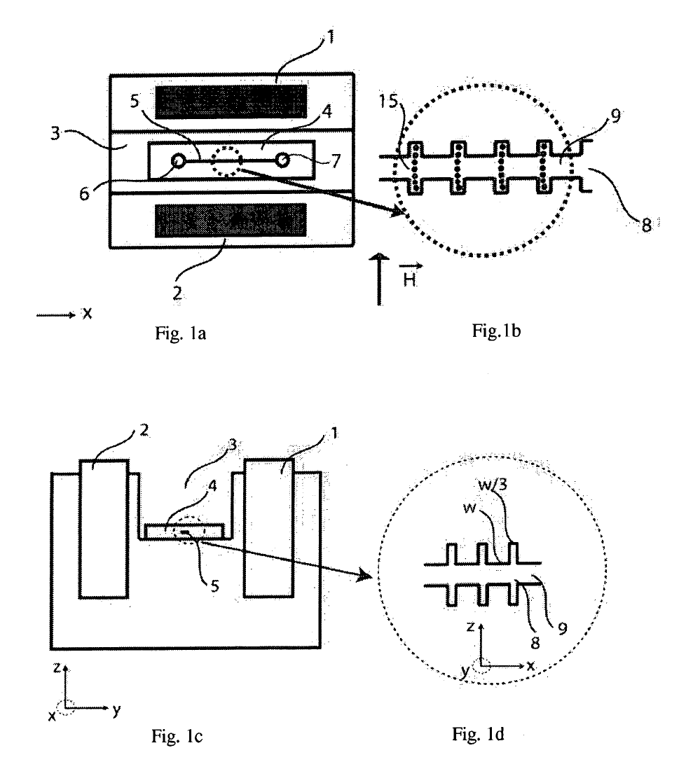

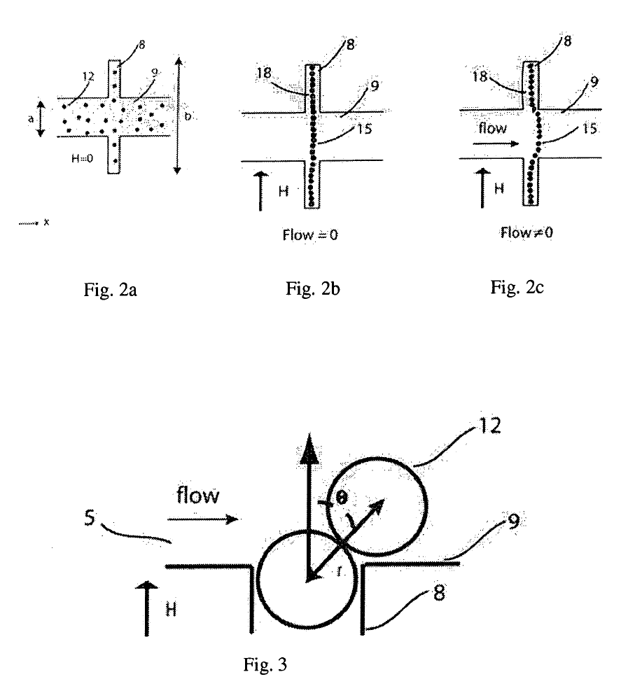

FIG. 1 schematically shows an apparatus according to the invention for retaining magnetic particles in self-assembled magnetic particle structures in a liquid flow, seen in plan view in FIG. 1a and end view in FIG. 1c. The apparatus comprises a microfluidic flow-through channel 5 in which in use magnetic particles are suspended in a liquid that is flowable through the channel 5. For example, two permanent magnets, or electro-magnets, 1,2 are arranged for generating a substantially static magnetic field across the channel 5 such that when magnetic particles 12 (FIG. 2a) are suspended in a liquid in channel 5 and a magnetic field H is applied the particles form magnetic particle structures 15 (FIG. 1a; FIG. 2b) that are sustained by magnetic forces acting on the particles, as explained below in connection with FIGS. 2a to 2c.

The magnetic field H is typically comprised between 0.01 Tesla and 1 Tesla.

The micro-channel 5 is contained in a microchip 4 that can be loosely placed (or fixed) in a recess 3 between the magnets 1,2. The microchip 4 is made of a plate of plastics material, or any other suitable non-magnetic material that has no magnetic shielding effect on the magnetic field, this plate having therein a central longitudinal channel 5 that has inlets and outlets 6,7 for connection to an external supply of liquid containing magnetic particles and other components, depending on the end use. The flow of liquid in the micro-channel 5 can be produced by a hydrodynamic or electrokinetic (electrophoretic and electro-osmotic) pumping mechanism, not shown.

The apparatus is typically used with magnetic particles 12 in the range of the nanometer to a few micrometers. The size and the nature of the magnetic particles or beads 12 can of course vary for different applications. Typically, the chains 15 of magnetic particles are used to selectively capture target molecules, filter the liquid flowing in the micro-channel or catalyze chemical reactions at the surface of the magnetic chains.

As shown in FIGS. 1b and 1d, the micro-channel 5 has along its length transverse large sections 8 alternating with narrow sections 9. The large sections 8 are periodically distributed along and on either side of the narrow sections 9 and are arranged such that in use magnetic particle structures 15 form across the large sections 8 of channel 5, as shown in FIG. 2b. The liquid can flow along channel 5 through the narrow sections 9 and through corresponding middle parts of the magnetic particle structures 15 in the large sections 8 (FIG. 2c), the magnetic particle structures 15 being retained by engagement of end parts 18 of the magnetic particle structures in the large sections 8 of channel 5.

In FIG. 1c, W designates the spacing between the large sections 8, and the width of the large sections 8 along the direction of the channel 5 preferably corresponds to about W/3. These dimensions are typically of the order of a micrometer to a few tens of micrometers. The depth of the microchannel 5 is also typically one micrometer to a few tens of micrometers.

Of course, the dimensions of the large and narrow sections 8,9 of the channel 5 can be changed as well as their periodicity. Typically, the transverse width of the narrow sections 9 is between 1 μm and 100 μm, and the transverse width of the large sections 8 is between 1 μm and 10 μm.

The large section 8 of the micro-channel 5, when viewed from the top, can be rectangular, triangular or round tapered shapes.

The invention implements a very simple solution for forming and retaining the magnetic particle structures 15, by providing a microfluidic channel 5 with varying cross section perpendicular to the flow. FIG. 2a shows such a channel with a smaller section 9 of size a and a larger section 8 of size b. For example, a=30 μm, and b=60 μm. The depth of the channel 5, perpendicular to the plane of the drawing, can be a few micron, as is common in a microfluidic device. When the structure of FIG. 2a contains a liquid sample solution containing superparamagnetic beads 12, and in the absence of a magnetic field H, these particles/beads 12 are loosely suspended in solution. However, in the presence of a field H, magnetic dipoles are induced, nucleating the chains in the area of largest cross-section b whereby the individual particles 12 start to cluster in chains 15 in order to minimize their magnetic energy, as illustrated in FIG. 2b. No separate magnetic film is needed to nucleate and form the chains, contrary to the arrangement proposed by Yellen and Friedman. When one now applies a fluid flow, the magnetic particle chain 15 is deformed, but stays connected up to a critical flow, as shown in FIG. 2c.

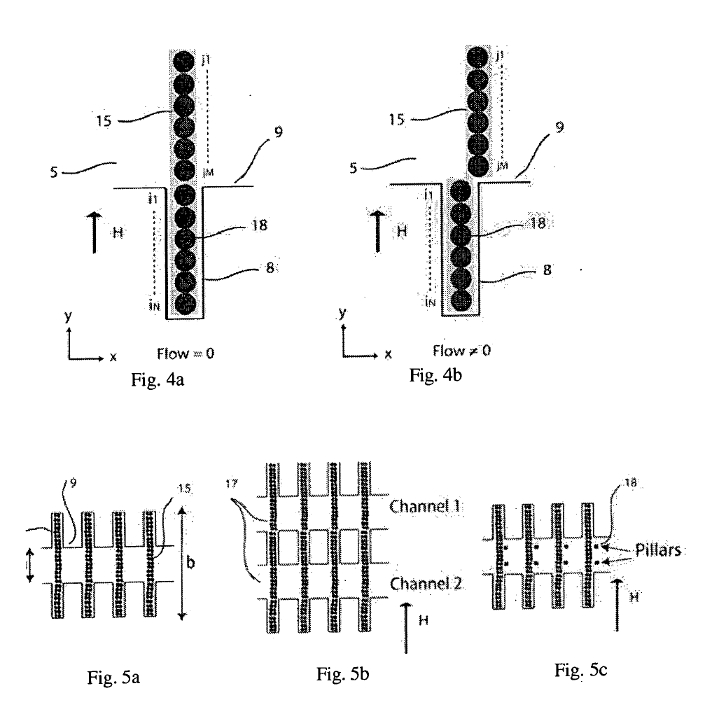

If desired or necessary, the micro-channel 5 can comprise sub-structures along the channel axis for enhanced retention of the magnetic chains 15, for example, micro-pillars (like the pillars shown in FIG. 4c) placed just downstream of the middle parts of the magnetic chains 15.

The chains 15 of magnetic particles are formed at the position of the largest section b, for two reasons. First of all, a longer chain is characterised by a smaller magnetic demagnetisation factor in the direction of the field H and hence forms a magnetic object with lower magnetostatic energy than a shorter chain. This explains the situation of FIG. 2b. Secondly, when a fluid flow is applied (FIG. 2c), shear forces act to the chain 15 and a maximum shear force will occur at the point where the width of the channel 5 goes from a to b. If we magnify the two particles 12 at the lower part of the channel 5, we see that the maximum dipolar force is obtained when the angle θ defined with respect to the field is 45°. This can be understood by analysis the forces taking effect on a magnetic chain. A magnetic chain that forms in the microfluidic channel structure consists of many individual particles. FIG. 4 shows a chain formed by N particles (i₁, i₂, . . . , i_{N}) in the lower part and a chain formed by M particles (j₁, j₂, . . . , j_{M}) in the middle part of the channel structure. The magnetostatic interaction energy between both chains can be calculated as the summation of all mutual dipole-dipole interactions in the two-chain structure. However, the largest contribution to the interaction energy of both chains originates from the interaction between particle i₁ and j_{M}, as their distance is shortest. Therefore, as a first approximation to the chain-chain magnetostatic energy, the magnetostatic interaction energy between these two particles as simply described by equation (1), can be considered. The magnetic interaction energy between two dipoles is given by:

$$U = - \frac{{m}^{2}}{4 {πμ}_{0}} \frac{1 - 3 {cos}^{2} θ}{{r}^{3}} \qquad Equation 1$$

where m is the dipole moment of a magnetic bead 12 induced by the field, μ₀ is the magnetic permeability of the vacuum, r the distance between the particle centres and θ the angle between the applied magnetic field and the line joining the beads centres. FIG. 3 is a schematic diagram of two beads 12 of a magnetic chain 15, where it can be seen that the lower particle 12 is held by the physical shape of the microchannel 5, while the top particle 12 is subjected to the flow.

When assuming the distance between the particles fixed (spherical particles), the tangential contribution to the total retained force is defined as:

$${F}_{θ} = - \frac{1}{r} \frac{\partial U}{\partial θ} = - \frac{{m}^{2}}{4 {πμ}_{0}} \frac{3 sin 2 θ}{{r}^{4}} \qquad Equation 2$$

which give a maximum tangential force for θ=45°. Suppose that there is not a single magnetic chain 15 formed within the cavity of dimension b, but a larger magnetic structure 15 containing N coupled uni-dimensional magnetic chains, this force can be multiplied by N and doubled as the chain 15 is held from the two sides. Therefore the total tangential magnetic force can be approximated by:

F_{θtot}=N·2F_{θ} Equation 3

When a chain 15 is formed, and exposed to a viscous drag force (which can be generated by a pressure, capillary or electroosmotic-based force), one can estimate the dragging force, by assuming the chain 15 as a cylinder:

$${F}_{visq , cylinder} = - \frac{4 πηα}{ln ( \frac{α}{β} ) + 0 , 5} {v}_{flow} \qquad Equation 4$$

where α is the cylinder length and β its radius, η the dynamic viscosity of the fluid and ν_{flow} the flow velocity.

A chain 15 will resist to the flow without rupture, as long as the tangential force is higher than the dragging force, i.e. F_{θtot}>F_{νisq,cylinder} for a stable chain. For example, with 1.5 μm diameter beads, a channel dimension of a=50 μm and b=70 μm, N=4, the F_{θtot} calculated is 1.66×10⁻¹⁰ N in a field of 0.12 T. In these conditions, a 50 μm length and 5 μm diameter cylinder formed by the magnetic beads will resist up to a 1 mm/s flow velocity.

Following the same argument, an array of cavities along the channel 5 will lead to the formation of a long-scale periodic structure 15 (made by many cylinders formed by the beads) inside the channel (FIG. 5a). Thereby, an array made of parallel channels (Channel 1 and Channel 2) interconnected by cavities 8 will lead to a panel 17 of parallel structures (FIG. 5b).

Furthermore, the magnetic retention force within a channel 9 can be increased by adding pillar-like structures or posts 19 in the channel (FIG. 5c). Each post 19 will create another holding spot for the chain, increasing the retention force by an amount 2 F_{θtot}.

### Experimental Example

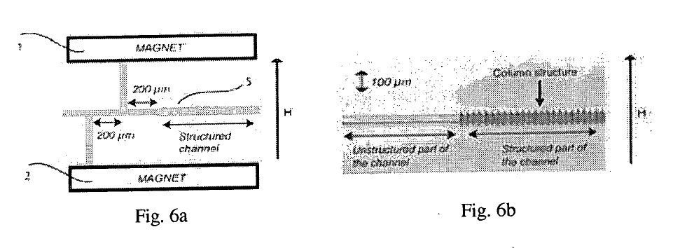

A classical electrophoresis microchip with structured microchannels, flanked with two permanent magnets can be used for realisation of this device. FIG. 6a shows a schematic diagram of the chip for retaining magnetic beads against a flow. FIG. 6b is a picture of an experimental array of magnetic chains contained inside the microchannel.

### Applications of the Invention

This invention can be used in various fluidic microsystems. Magnetic chains 15 by virtue of their high interaction with the liquid can capture or retain molecules, cells or particles carried by the liquid. The magnetic beads 12 can be coated with specific chemical groups, and have the role of probe for specific molecules.

By choosing proper chemical groups (for example a well know single strand of a DNA or RNA molecule), one can capture the complementary strand. Therefore, due to the high specific interactions between the probe molecule on the bead and the target molecule carried by the flow, specific DNA or RNA molecules can be isolated from a complex mixture of molecules (a cell lyses solution for example). In a similar way, the magnetic chains 15 will capture target molecules from solution containing these molecules even in very low concentrations. One can later recover and concentrate the target molecules from the beads in a smaller volume. The molecules can then be used for analysis or PCR, for example.

Another promising application of the invention can be magnetic bead bio-sampling like use in a sandwich immunoassay. In this case, magnetic beads coated with specific antibodies would be used. A solution containing antigens will flow through the beads, and only the target antigens will be immobilized on the surface of the coated beads, while other antigen and undesired molecules will be washed out. The captured antigens can be released (and concentrated in a same way as above for the DNA or RNA), or labelled secondary antibodies can be flown over the beads and incubated with the immobilised antigens. Then, detection can be performed on-chip before washing the beads and starting another assay. The invention can be also used with any analytical procedure that requires interaction between antibody-coated beads and antigens. On-chip protein digestion can also be performed.

Another interesting field of use of the invention can be in a microreactor. It is well known that a large amount of chemical reactions can take place in a microchip with a catalyst (atoms or small molecules) fixed on the walls of the microchip. The molecules used for catalysing the chemical reactions can be immobilised on magnetic beads. Due to the high interactions between the reagents and the catalyst on the bead (which leads to a complete reaction), its flexibility and the very small amount of reagents used (typically few hundreds of nanoliters to few tens of microliters), the invention can have an important impact in pharmacology research and development.

1. An apparatus for retaining magnetic particles in self-assembled magnetic particle structures in a liquid flow, comprising a flow-through cell or channel (5) in which magnetic particles are suspendable in a liquid that is flowable through the cell or channel, and means (1,2) for generating a substantially static magnetic field across the cell or channel (5) such that when magnetic particles (12) are suspended in a liquid in the cell or channel (5) and said magnetic field is applied the particles form magnetic particle structures (15) that are sustained by magnetic forces acting on the particles,
wherein:
the flow-through cell or channel (5) has along its length transverse large sections (8) alternating with narrow sections (9), with the large sections (8) periodically distributed along and on either side of the narrow sections (9) and arranged such that in use magnetic particle structures (15) form across the large sections (8) of the cell or channel (5), the liquid being flowable along the cell or channel (5) through said narrow sections (9) and through corresponding middle parts of the magnetic particle structures (15) in the large sections, the magnetic particle structures (15) being retained by engagement of end parts (18) of the magnetic particle structures in the large sections (8) of the cell or channel (5).

2. The apparatus of claim 1, wherein the means for generating a substantially static magnetic comprise first and second permanent magnets or electro-magnets (1,2) spaced apart across a free space for receiving the flow-through cell or channel (5).

3. The apparatus of claim 1 wherein the flow-through cell or channel (5) is incorporated in a microchip (4) having at least one inlet (6) and outlet (7) for connection of the flow-though cell or channel (5) to a source of liquid.

4. The apparatus of claim 1 wherein the spacing between the large sections (8) is larger than the dimension along the length of the channel (5) of the large sections (8).

5. The apparatus of claim 4, wherein the spacing between the large sections (8) is W, and the dimension along the length of the channel (5) of the large sections (8) is from W/2 to W/4, preferably about W/3.

6. The apparatus of claim 1, arranged for forming magnetic structures (15) from particles (12) whose size is in the range of the nanometer to a few micrometers.

7. The apparatus of claim 1, comprising a hydrodynamic or electrokinetic pumping mechanism for flowing liquid to the cell or channel (5).

8. The apparatus of claim 1, wherein the transverse width of the narrow sections (9) is between 1 μm and 100 μm, and the transverse width of the large sections (8) is between 1 μm and 10 μm.

9. The apparatus of claim 1, wherein the magnetic field across the cell or channel (5) is comprised between 0.01 Tesla to 1 Tesla.

10. The apparatus of claim 1, wherein the large sections (8), when viewed from the top, are of rectangular, triangular or round tapered shapes.

11. The apparatus of claim 1, wherein the cell or channel (5) contains micropillar substructures (19) in the narrow sections (9) for enhanced retention of the magnetic structures (15).

12. A method for retaining magnetic particles in self-assembled magnetic particle structures in a liquid flow in a flow-through cell or channel (5) in which magnetic particles are suspended in a liquid that is flowable through the cell or channel, comprising generating a substantially static magnetic field across the cell or channel (5) such that magnetic particles (12) suspended in liquid in the cell or channel (5) form under the action of said magnetic field magnetic particle structures (15) that are sustained by magnetic forces acting on the particles, wherein the flow-through cell or channel (5) has along its length transverse large sections (8) alternating with narrow sections (9), with the large sections (8) periodically distributed along and on either side of the narrow sections (9), such that magnetic particle structures (15) form across the large sections (8) of the cell or channel (5), the liquid being flowable along the cell or channel (5) through said narrow sections (9) and through corresponding middle parts of the magnetic particle structures (15) in the large sections, the magnetic particle structures (15) being retained by engagement of end parts (18) of the magnetic particle structures in the large sections (8) of the cell or channel (5).

13. The method of claim 12, comprising flowing through the cell or channel (5) a fluid carrying molecules or particles to be captured, filtered or activated by the magnetic structures (15).

14. The method of claim 12 wherein the magnetic structures (15) formed in the larger cross-sections (9) of the cell or channel (5) form a periodic structure along the cell or channel axis.

15. The method of claim 12 wherein the cell or channel (5) is in a microchip that is freely placed between magnets (1,2) producing the magnetic field.

16. The method of claim 12 which is performed in a life science, chemistry or microfiltration application.

17. The method of claim 16 in an in-vitro diagnostic assay, in electrophoretic or chromatographic separations, in high performance liquid chromatography or in a catalysis application involving the magnetic particles.
